(19) United States
(12) Patent Application Publication
(10) Pub. No.: US 2009/0155657 A1
(43) Pub. Date: Jun. 18, 2009

(54) Hydrogen Permeable Film, and Fuel Battery Using the Same

(76) Inventors: Osamu Mizuno, Hyogo (JP); Masahiko Iijima, Saitama (JP)

Correspondence Address: MCDERMOTT WILL & EMERY LLP, 600 13TH STREET, N.W., WASHINGTON, DC, 20005-3096, US

(21) Appl. No.: 11/991,910

(22) PCT Filed: Sep. 21, 2006
(86) PCT No.: PCT/JP2006/318745

§ 371 Date: Mar. 12, 2008

(30) Foreign Application Priority Data
Sep. 27, 2005 (JP) 2005 279140

(51) Int. Cl. H01M 8/10; B32B 15/01

(52) U.S. Cl. 429/30; 428/615

(57) ABSTRACT

A hydrogen permeable film (1) includes a hydrogen permeable base material (2) including V or a V alloy, a Pd film (3) including Pd or a Pd alloy and having hydrogen permeability, and an intermediate layer (4) provided between the hydrogen permeable base material (2) and the Pd film (3) and including a first intermediate layer (5) in contact with the hydrogen permeable base material (2) and a second intermediate layer (6) in contact with the Pd film (3). The first intermediate layer (5) includes at least one selected from the group consisting of Ta, Nb and an alloy thereof and the second intermediate layer (6) includes at least one selected from the group consisting of a Group 8 element, a Group 9 element, a Group 10 element and an alloy thereof and has a thickness of 1-100 nm. A fuel battery includes a proton conductive film on a Pd film of such a hydrogen permeable film. With such a hydrogen permeable film and a fuel battery, mutual diffusion between the hydrogen permeable base material, the intermediate layer and the Pd film is reduced and the problem of decrease of hydrogen permeability over time is solved as well as decrease of electromotive force over time is also reduced.

### TECHNICAL FIELD

The present invention relates to a hydrogen permeable film having high hydrogen permeability and hydrogen selectivity in which decrease of hydrogen permeability over time is small, and a fuel battery using the hydrogen permeable film.

### BACKGROUND ART

Hydrogen permeable films have hydrogen permeability and hydrogen selectivity for selective permeation of only hydrogen from a mixed gas of hydrogen and other gases, and are widely used for extraction of hydrogen from a gas containing hydrogen as well as for fuel batteries.

As a hydrogen permeable film, various films including a Group 5 element such as vanadium (V), niobium (N), tantalum (Ta) and the like or palladium (Pd) that has superior hydrogen permeability have been proposed. Among them, Pd is inferior in hydrogen permeability to Group 5 elements such as V, Nb, Ta and the like, however, Pd is superior in resistance to oxygen in the outside air and the like as well as in ability to generate atomic hydrogen, which is necessary for use in a fuel battery, on a film surface. Meanwhile, Pd is very expensive. Among Group 5 elements, Ta is also expensive since a small amount of Ta reserves is available. Further, compared with V, the amount of hydrogen-induced expansion of Nb is large and Nb is hard and tends to be broken easily.

Accordingly, a hydrogen permeable film has been proposed which has a thin film of Pd (a coating layer) formed on a surface of a hydrogen permeable base material mainly composed of V or a V alloy by vapor deposition, sputtering, plating or the like (for example, see Japanese Patent Laying-Open No. 07-185277 (Patent Document 1) and Japanese Patent Laying-Open No. 2004-344731 (Patent Document 2)).

Hydrogen permeability of V or Pd is highest at 300-600° C. and use of a hydrogen permeable film in the temperature range is industrially advantageous. If the a hydrogen permeable film having a Pd film as a coating layer formed on the surface of a hydrogen permeable base material mainly composed of V or a V alloy as mentioned above is used in the temperature range, however, there is a problem that mutual diffusion between Pd in the coating layer and V or a V alloy included in the hydrogen permeable base material occurs and hydrogen permeability decreases over time. Accordingly, there has been proposed a hydrogen permeable film in Patent Document 1 and the like having an intermediate layer interposed between the coating layer and the hydrogen permeable base material, for example.

Patent Document 1: Japanese Patent Laying-Open No. 07-185277

Patent Document 2: Japanese Patent Laying-Open No. 2004-344731

### DISCLOSURE OF THE INVENTION

### Problems to be Solved by the Invention

As disclosed in Patent Document 1, mutual diffusion between a hydrogen permeable base material and a coating layer is reduced by forming an intermediate layer between the coating layer and the hydrogen permeable base material. In this configuration, however, mutual diffusion between a Pd film as the coating layer and the intermediate layer occurs. In particular, it has been difficult to prevent diffusion of Pd in the coating layer into the intermediate layer. It has been also difficult to reduce decrease of hydrogen permeability over time to a satisfactory degree. Further, there has been a problem that hydrogen permeability deteriorates if Ni or the like is used for the intermediate layer.

The present invention has been made to solve the above-mentioned problems. An object of the present invention is to provide a hydrogen permeable film including an intermediate layer between a hydrogen permeable base material including V or a V alloy and a Pd film, wherein mutual diffusion between the hydrogen permeable base material, the intermediate layer and the Pd layer can be reduced and the problem of the decrease of hydrogen permeability over time is improved. Another object of the present invention is to provide a fuel battery using the above-described hydrogen permeable film wherein the problem of the decrease over time is improved.

### Means for Solving the Problems

After thorough consideration, the inventors of the present invention has found that the above-mentioned problem can be solved by providing a layer that is included in the intermediate layer, located on the Pd film and including an element selected from Group 8, Group 9 or Group 10 elements to complete the present invention. The present invention is as described below.

A hydrogen permeable film according to the present invention includes a hydrogen permeable base material including V or a V alloy, a Pd film including Pd and having hydrogen permeability and an intermediate layer provided between the hydrogen permeable base material and the Pd film and including a first intermediate layer in contact with the hydrogen permeable base material and a second intermediate layer in contact with the Pd film, wherein the first intermediate layer includes at least one selected from the group consisting of Ta, Nb and an alloy thereof and the second intermediate layer includes at least one selected from the group consisting of a Group 8 element, a Group 9 element, a Group 10 element and an alloy thereof and has a thickness of 1 nm-100 nm.

In the hydrogen permeable film according to the present invention, preferably, the first intermediate layer is 10 nm-500 nm in thickness.

Further, the present invention also provides a fuel battery including a hydrogen permeable film of the present invention as described above and a proton conductive film provided on the Pd film of the hydrogen permeable film.

### EFFECTS OF THE INVENTION

With a hydrogen permeable film according to the present invention, mutual diffusion between a hydrogen permeable base material, an intermediate layer and a Pd layer that occurs in a conventional hydrogen permeable film including the hydrogen permeable base material, the intermediate layer and the Pd film is reduced, and decrease of hydrogen permeability over time is reduced even if the hydrogen permeable film is used at 300-600° C. Thus, the hydrogen permeable film according to the present invention with high hydrogen permeability and reduced deterioration over time can be suitably used for a hydrogen extractor (a hydrogen separation film) that extracts hydrogen from a gas containing hydrogen, a hydrogen sensor, a fuel battery and the like.

With a fuel battery having a proton conductive film provided on the Pd film of such a hydrogen permeable film according to the present invention, superior electromotive force can be obtained and decrease of electromotive force over time can be reduced.

### BRIEF DESCRIPTION OF THE DRAWINGS

FIG. 1 is a schematic cross-sectional view of a hydrogen permeable film 1 of a preferred example of the present invention.

FIG. 2 is a schematic cross-sectional view of a fuel battery 11 of a preferred example of the present invention.

### DESCRIPTION OF THE REFERENCE SIGNS

1, 12 hydrogen permeable film, 2 hydrogen permeable base material, 3 Pd film, 4 intermediate layer, 5 first intermediate layer, 6 second intermediate layer, 11 fuel battery, 13 metallic porous base material, 14 proton conductive film, 15 oxygen electrode

### BEST MODES FOR CARRYING OUT THE INVENTION

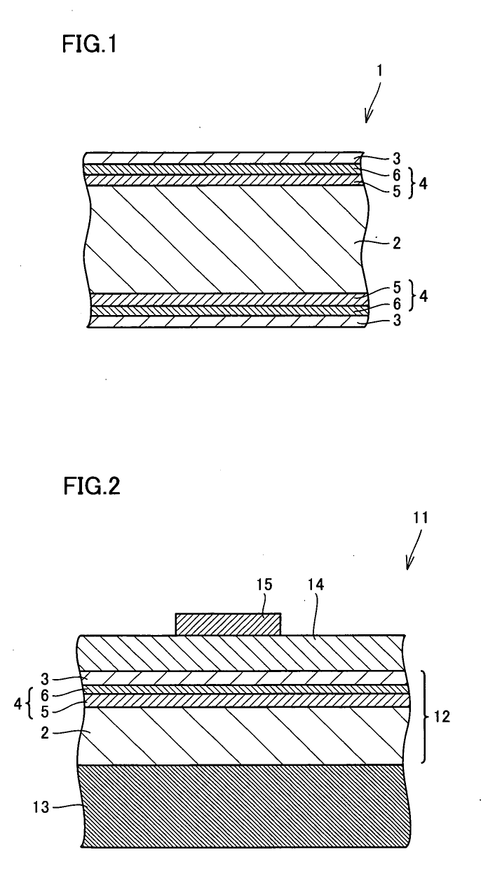

FIG. 1 is a schematic cross-sectional view of a hydrogen permeable film 1 of a preferred example of the present invention. Hydrogen permeable film 1 according to the present invention basically includes a hydrogen permeable base material 2, a Pd film 3, and an intermediate layer provided therebetween. Hydrogen permeable film 1 according to the present invention has a feature that intermediate layer 4 has a first intermediate layer 5 in contact with hydrogen permeable base material 2 and a second intermediate layer 6 in contact with Pd film 3 and that first and second intermediate layers 5, 6 are each composed of a particular material.

With such a hydrogen permeable film 1 according to the present invention, mutual diffusion between the hydrogen permeable base material, the intermediate layer and the Pd film that occurs in a conventional hydrogen permeable film can be reduced, and even when use is made at 300-600° C., decrease of hydrogen permeability over time is small. As used herein, “hydrogen permeability is high” means that the amount of hydrogen permeated per unit time by a hydrogen permeable film in the form of a disk of 10 mm in diameter, under the conditions of a temperature of 600° C. and a differential pressure of hydrogen between the two opposite surfaces of the hydrogen permeable film Δ of 0.04 Mpa, is at least 100 Nm³/m²/Pa^{1/2} (suitably at least 200 Nm³/m²/Pa^{1/2}). Further, as used herein, “decrease of hydrogen permeability over time is small” means that when the amount of permeated hydrogen is measured continuously in the measurement method as described above, the amount of permeated hydrogen decreases by 30% from the initial amount of permeated hydrogen 1000 minutes (suitably 1500 minutes) after the beginning of the measurement.

Hydrogen permeable base material 2 in the present invention includes V (vanadium) that is a Group 5 element in the periodic table, or a V alloy. An alloy of V and Ni (nickel), V and Ti (titanium), V and Co (cobalt), V and Cr (chromium) and the like can be taken as an example of a V alloy.

The percentage of the content of V or a V alloy in hydrogen permeable base material 2 is not specifically limited, however, it is preferably at least 70%, and more preferably, it is within a range of 80-100%, since rolling processing tends to be difficult due to hardness when the percentage of the content of V or a V alloy is less than 70%. In particular, hydrogen permeable base material 2 is preferably composed of V or a V alloy alone. The percentage of the content of V or a V alloy in hydrogen permeable base material 2 can be measured by ICP (Inductively Coupled Plasma) spectroscopic analysis, for example. Hydrogen permeable base material 2 may include a component other than V or a V alloy as long as effects of the present invention are not impaired, and Nb, Ta, Ti, Zr, Fe, C, Sc and the like can be taken as an example of such a component.

The thickness of hydrogen permeable base material 2 in the present invention is not specifically limited, however, it is preferably within a range of 10-500 μm and more preferably, within a range of 20-100 μm. If the hydrogen permeable base material 2 is less than 10 μm in thickness, it tends to be broken easily and is hard to handle. If hydrogen permeable base material 2 is more than 500 μm in thickness, hydrogen permeability tends to decrease. The thickness of hydrogen permeable base material 2 can be measured by a micrometer, for example.

Pd film 3 in the present invention includes Pd (palladium) or a Pd alloy. An alloy of Pd and Ag (silver), Pd and Pt (platinum), Pd and Cu (copper) and the like can be taken as an example of a Pd alloy. The percentage of the content of Pd or a Pd alloy in Pd film 3 is not specifically limited.

Pd film 3 in the present invention has hydrogen permeability. As used herein, “having hydrogen permeability” means that the amount of permeated hydrogen measured using a Pd film (100 μm in thickness) instead of the hydrogen permeable film in the method to measure the amount of permeated hydrogen as described above is at least 5 Nm³/m²/Pa^{1/2} (suitably, at least 10 Nm³/m²/Pa^{1/2}).

The thickness of Pd film 3 in the present invention is not specifically limited, however, it is preferably within a range of 0.05-2 μm, and more preferably, within a range of 0.1-1 μm. If Pd film 3 is less than 0.05 μm in thickness, it cannot coat the intermediate layer or the hydrogen permeable base material sufficiently, so that a constituent material for them that includes a Group 5 element will be oxidized and deteriorated. If Pd film 3 is more than 2 μm in thickness, increased cost may be a problem since the amount of expensive Pd used is increased. The thickness of Pd film 3 can be measured in the same manner as mentioned regarding the thickness of hydrogen permeable base material 2.

Intermediate layer 4 in the present invention has first intermediate layer 5 in contact with hydrogen permeable base material 2 and second intermediate layer 6 in contact with Pd film 3. First intermediate layer 5 and second intermediate layer 6 may be each a single layer or a plurality of layers.

Hydrogen permeable film 1 according to the present invention is characterized in that first intermediate layer 5 formed to be in contact with hydrogen permeable base material 2 includes at least one selected from the group consisting of Ta (tantalum), Nb (niobium) of Group 5 (Group VA) elements in the periodic table, and an alloy thereof. An alloy of Ta or Nb and Ni, Ti, Co, Cr and the like can be taken as an example of a Ta alloy or an Nb alloy. To note, first intermediate layer 5 in the present invention does not include V that is an element of the same Group 5.

The percentage of the content of at least one selected from the group consisting of Ta, Nb and an alloy thereof in first intermediate layer 5 in the present invention is not specifically limited. Preferably, first intermediate layer 5 is composed of only at least one selected from the group consisting of Ta, Nb and an alloy thereof, and in particular, preferably, it is composed of only Ta or its alloy, or of Nb or its alloy. The percentage of the content of at least one selected from the group consisting of Ta, Nb and an alloy thereof in first intermediate layer 5 can be measured by ICP, for example.

Preferably, the thickness of first intermediate layer 5 in the present invention is within a range of 10-500 nm, and more preferably, within a range of 100-200 nm. The thickness of first intermediate layer 5 can be measured by observing the cross section with an electron microscope.

First intermediate layer 5 is superior in hydrogen permeability, and thus does not impair hydrogen permeability of hydrogen permeable film 1 as a whole. In addition, with first intermediate layer 5, mutual diffusion between hydrogen permeable base material 2 and Pd film 3 can be reduced. To make the effect of reducing the mutual diffusion more sufficient, the thickness of first intermediate layer 5 (the total thickness if first intermediate layer 5 is composed of a plurality of layers on one of the surfaces of hydrogen permeable base material 2) is preferably at least 10 nm.

There is a case where hydrogen permeable base material 2 including V or a V alloy and first intermediate layer 5 cause hydrogen-induced expansion due to production of a hydride when hydrogen permeates therethrough. Since hydrogen permeable base material 2 and first intermediate layer 5 includes mutually different Group 5 elements, difference in hydrogen-induced expansion may occur, which may lead to damage to film. To avoid damage to film, the thickness of first intermediate layer 5 (the total thickness if first intermediate layer 5 is composed of a plurality of layers on one of the surfaces of hydrogen permeable base material 2) is preferably not more than 500 nm.

Hydrogen permeable film 1 according to the present invention is characterized in that second intermediate layer 6 formed to be in contact with Pd film 3 includes at least one selected from the group consisting of Group 8, Group 9 and Group 10 (Group VIII) elements in the periodic table and an alloy thereof. With second intermediate layer 6 in contact with Pd film 3, hydrogen permeable film 1 according to the present invention can reduce mutual diffusion between Pd film 3 and first intermediate layer 5, in particular, decrease of the amount of permeated hydrogen over time due to thermal diffusion of Pd into first intermediate layer 5 in the environment of 300-600° C. that are preferable temperatures for use of hydrogen permeable film 1, and decrease of the amount of permeated hydrogen over time due to a Group 5 element appearing on the outer surface of Pd film 3 (i.e. the outermost surface of hydrogen permeable film 1) and being oxidized.

Co, Fe (iron), Ni and the like can be taken as examples of elements of Group 8, Group 9 and Group 10 included in second intermediate layer 6. Fe—Ni alloy, Fe—Co alloy and the like can be taken as an example of an alloy of the elements.

To make the effect of reducing mutual diffusion between Pd film 3 and first intermediate layer 5 sufficient, the thickness of second intermediate layer 6 (the total thickness if second intermediate layer 6 is composed of a plurality of layers on one of the surfaces of hydrogen permeable base material 2) is at least 1 nm. If the thickness of second intermediate layer 6 (the total thickness if second intermediate layer 6 is composed of a plurality of layers on one of the surfaces of hydrogen permeable base material 2) is more than 100 nm, hydrogen permeability deteriorates. In hydrogen permeable film 1 according to the present invention, the thickness of second intermediate layer 6 is within a range of 1-100 nm, and preferably, within a range of 10-50 nm. The thickness of second intermediate layer 6 can be measured in the same manner as mentioned regarding the thickness of hydrogen permeable base material 2.

As described above, it is sufficient that hydrogen permeable film 1 according to the present invention includes a basic configuration in which intermediate layer 4 having first and second intermediate layers 5, 6 is interposed between hydrogen permeable base material 2 and Pd film 3, and Pd film 3 and intermediate layer 4 may be formed only on one surface of hydrogen permeable base material 2 or on both surfaces of hydrogen permeable base material 2. FIG. 1 shows a case where first intermediate layer 5, second intermediate layer 6 and Pd film 3 are laminated in this order from hydrogen permeable base material 2 on both surfaces of hydrogen permeable base material 2. As shown in FIG. 1, if intermediate layer 4 and Pd film 3 are formed on both surfaces of hydrogen permeable base material 2, intermediate layer 4 and Pd film 3 formed on one surface may be implemented to be the same as intermediate layer 4 and Pd film 3 formed on the other surface in composition, number of layers and thickness, or may be implemented to be different in at least one of composition, number of layers and thickness.

Further, hydrogen permeable film 1 according to the present invention is not specifically limited in shape, and can be implemented in various shapes such as a disk, a plate (rectangular in cross section) and the like.

The thickness of hydrogen permeable film 1 according to the invention as a whole is not specifically limited, and is preferably within a range of 15-600 μm, and more preferably, within a range of 21-550 μm. If the thickness of hydrogen permeable film 1 is less than 15 μm, strength of the hydrogen permeable film is insufficient and the hydrogen permeable film may be broken. If the thickness of hydrogen permeable film 1 is more than 600 μm, the amount of permeated hydrogen will decrease. To note, the thickness of hydrogen permeable film 1 as a whole can be measured in the same manner as mentioned regarding the thickness of hydrogen permeable base material 2.

A method of fabricating hydrogen permeable film 1 according to the present invention is not specifically limited and hydrogen permeable film 1 can be fabricated using a conventionally known method appropriately. For example, at first, first intermediate layer 5 is formed on hydrogen permeable base material 2 using vapor deposition, sputtering, ion plating, plating or the like. Then, second intermediate layer 6 is formed on first intermediate layer 5 using vapor deposition, sputtering, ion plating, plating or the like, and in addition, Pd film 3 is formed thereon using vapor deposition, sputtering, ion plating, plating or the like. Thus, hydrogen permeable film 1 according to the present invention can be suitably fabricated.

If hydrogen permeable film 1 according to the present invention is used for a fuel battery, as described below, it is desirable that a perovskite film be formed on Pd film 3 to obtain high electromotive force. In this case, it is preferable that Pd film 3 be dense, without a pinhole, and in order to make such a dense Pd film, it is preferable to form a Pd film by ion plating.

As described above, in hydrogen permeable film 1 according to the present invention, hydrogen permeability is high and deterioration of hydrogen permeability over time is reduced. Such a hydrogen permeable film 1 according to the present invention can be suitably used for a hydrogen extractor that extracts hydrogen from a gas containing hydrogen, a hydrogen sensor, a fuel battery and the like.

FIG. 2 is a schematic cross-sectional view of a fuel battery 11 of a preferred example of the present invention. The present invention also provides fuel battery 11 including hydrogen permeable film 12 according to the present invention as described above and a proton conductive film 14 on Pd film 3 of hydrogen permeable film 1. Hydrogen permeable film 12 used for fuel battery 11 shown in FIG. 2 is similar to hydrogen permeable film 1 of the example shown in FIG. 1 except that first intermediate layer 5, second intermediate layer 6 and Pd film 3 are formed on only one of the surfaces of hydrogen permeable base material 2. Any similar component is designated by the same reference character and description thereof will not be repeated here. In fuel battery 11 of the example shown in FIG. 2, first intermediate layer 5, second intermediate layer 6 and Pd film 3 are formed on one of the surfaces of hydrogen permeable base material 2, and in addition, on Pd film 13, proton conductive film 4 and oxygen electrode 15 are formed. The surface of hydrogen permeable base material 2 where first intermediate layer 5, second intermediate layer 6 and Pd film 3 are not formed is provided on a metallic porous base material 13.

Such a fuel battery 11 according to the present invention offers benefits of superior electromotive force and reduced decrease of electromotive force over time. As used herein, “superior electromotive force” means that electromotive force of a fuel battery is at least 1.0 V (suitably at least 1.1 V). Electromotive force of a fuel battery can be measured using an electrochemical measurement device Potentiostat/Galvanostat (produced by Solartron), for example. In addition, “reduced decrease of electromotive force over time” means that electromotive force decreases by 10% from the initial electromotive force 10 hours (suitably 24 hours) after the beginning of measurement when the electromotive force is continuously measured in the method as described above.

Proton conductive film 14 used for fuel battery 11 according to the present invention is a film of a solid electrolyte that has a characteristic that a proton (H⁺, proton) is propagated therewithin. For such a proton conductive film 14, any conventionally known proton conductive film can be used appropriately. The present invention is not specifically limited, however, a film composed of an oxide including a metal such as an alkaline earth metal, Ce, Zr and the like can be taken as an example of proton conductive film 14. In particular, a film of an oxide represented by a chemical formula AₓM_{y}L_{z}O₃ (wherein A is an alkaline earth metal, M is a metal such as Ce and Zr, L is an element of Group 3 and Group 13, x is about 1-2, y+z is about 1, and z/(y+z) is about 0-0.8) can be suitably used, and a film of an oxide having a crystal structure of a perovskite type is particularly suitable since high proton conductivity and high electromotive force can be obtained. In the above chemical formula, the element represented by L also includes an element of the lanthanoid series, and more specifically, Ga, Al, Y, Yb, In, Nd and Sc can be taken as an example.

In fuel battery 11 according to the present invention, the thickness of proton conductive film 14 is not specifically limited, however, it is preferably within a range of 0.1-20 μm, and more preferably, within a range of 1-10 μm. If the thickness of proton conductive film 14 is more than 20 μm, there may occur a problem that proton permeability is deteriorated and output of the cell is also deteriorated. The smaller the thickness of proton conductive film 14 is, the higher proton conductivity becomes. However, proton conductive film 14 of less than 0.1 μm in thickness has many film defects (pinholes) and allows hydrogen to passes through without ionization (protonation) more easily, so that it will not function as a solid electrolyte sufficiently. In the present invention, with proton conductive film 14 of the thickness in the above-mentioned range, the possibility that the above-mentioned problems may occur can be reduced while close contact with hydrogen permeable film 1 can be obtained.

The method of fabricating proton conductive film 14 is not specifically limited. Proton conductive film 14 can be formed (deposited) on Pd film 3 of hydrogen permeable film 12 by sputtering, electron beam vapor deposition, laser abrasion, CVD and the like, for example. Proton conductive film 14 may be formed by a wet process method such as sol-gel process (wet process).

Preferably, proton conductive film 14 is obtained by depositing at a temperature of at least 400° C. in an oxidative atmosphere, or by depositing at a temperature of not more than 400° C. and then performing sintering at a temperature of at least 400° C. in a non-oxidative atmosphere. Under such a condition, proton conductive film 14 having a perovskite structure can be obtained.

Fuel battery 11 of the example shown in FIG. 2 has oxygen electrode 15 formed on proton conductive film 14. Oxygen electrode 15 used for the present invention is not specifically limited, and a thin film electrode including Pd, Pt, Ni, Ru (ruthenium) and/or an alloy thereof, an applied electrode including a precious metal and/or a conductive oxide, or a porous electrode is preferably taken as an example of the oxygen electrode.

A thin film electrode can be obtained by depositing Pd, Pt, Ni, Ru and/or an alloy thereof on the uppermost layer of proton conductive film 14 by sputtering, electron beam vapor deposition, laser abrasion and the like. If oxygen electrode 15 is implemented as such a thin film electrode, the thickness is normally about 0.01-10 μm.

An applied electrode can be formed by applying Pt paste, Pd paste and/or a conductive oxide paste to proton conductive film 14 and performing baking, for example. If oxygen electrode 15 is implemented as such an applied electrode, the thickness is normally about 5-500 μm.

A porous electrode can be formed by screen-printing, for example. If oxygen electrode 15 is implemented as such a porous electrode, the thickness is normally about 1-100 μm.

In fuel battery 11 of the example shown in FIG. 2, the surface of hydrogen permeable base material 2 where first intermediate layer 5, second intermediate layer 6 and Pd film 3 are not formed is provided on metallic porous base material 13. Metallic porous base material 13 is a base material formed of a conductive metal and has a plurality of holes that allow hydrogen to pass through. A porous base material formed of SUS or the like can be taken as an example of such a metallic porous base material 13.

Hydrogen permeable base material 2 can be provided on metallic porous base material 13 by a method of depositing a material forming the hydrogen permeable base material and including V or a V alloy on the surface of metallic porous base material 13 by sputtering, electron beam vapor deposition, laser abrasion and the like, for example. Hydrogen permeable base material 2 may be provided on metallic porous base material 13 by a wet process such as plating and the like.

When fuel battery 11 of the example shown in FIG. 2 is in use, hydrogen in contact with the metallic porous base material 13 passes through metallic porous base material 13, hydrogen permeable base material 2, intermediate layer 4 (first intermediate layer 5 and second intermediate layer 6) and Pd film 3 to reach proton conductive film 14, where hydrogen emits an electron to become a proton. The proton passes through proton conductive film 14 to reach the oxygen electrode 15, where the proton obtains an electron and unites with oxygen present and around in the oxygen electrode 15 to produce water that is released from system. Giving and receiving of an electron between the metallic porous base material 13 and the oxygen electrode 15 produces electromotive force, which serves as a battery.

Although the present invention will be described in detail hereinafter in conjunction with examples and comparative examples, the present invention is not limited thereto.

### EXAMPLE 1

Commercially available V foil of 0.1 mm in thickness (in the form of a disk of 10 mm in diameter and 100 μm in thickness) was used as hydrogen permeable base material 2 and both surfaces thereof were coated with Ta by vapor deposition under the condition of a degree of vacuum of not more than 2×10⁻³ Pa and without heating of the substrate to form a Ta layer (first intermediate layer 5) of 0.03 μm (30 nm) in thickness. Then, likewise, the surface of each Ta layer was covered with Co to form a Co layer (second intermediate layer 6) of 0.03 μm (30 nm) in thickness. Further, likewise, the surface of each Co layer was coated with Pd to form Pd film 3 of 0.1 μm in thickness at the outermost layer. Thus, hydrogen permeable film 1 of the example shown in FIG. 1 was fabricated.

For the obtained hydrogen permeable film 1 in the form of a disk of 10 mm in diameter, the amount of permeated hydrogen per unit time was measured under the conditions of a temperature of 600° C. and a differential pressure of hydrogen between the two opposite surfaces Δ of 0.04 MPa. The measurement was continually conducted and it was found that the amount of permeated hydrogen decreased by 30% from the initial amount of permeated hydrogen 1500 minutes after the beginning of the measurement.

### EXAMPLE 2

Hydrogen permeable film 1 was fabricated in the same manner as in Example 1 except that second intermediate layer 6 was formed of Ni instead of Co. The measurement was conducted in the same manner as in Example 1 and it was found that the amount of permeated hydrogen decreased by 30% from the initial amount of permeated hydrogen 1200 minutes after the beginning of the measurement.

### EXAMPLE 3

Hydrogen permeable film 1 was fabricated in the same manner as in Example 1 except that commercially available V—Ni foil of 0.1 mm in thickness (in the form of a disk of 10 mm in diameter and 100 μm in thickness) was used as hydrogen permeable base material 2. The measurement was conducted in the same manner as in Example 1 and it was found that the amount of permeated hydrogen decreased by 30% from the initial amount of permeated hydrogen 1500 minutes after the beginning of the measurement.

### EXAMPLE 4

Hydrogen permeable film 1 was fabricated in the same manner as in Example 1 except that Pd film 3 as the outermost layer was formed with Pd—Ag alloy. The measurement was conducted in the same manner as in Example 1 and it was found that the amount of permeated hydrogen decreased by 30% from the initial amount of permeated hydrogen 1800 minutes after the beginning of the measurement.

### COMPARATIVE EXAMPLE 1

Both surfaces of the same V foil as used in Example 1 were coated with Pd by vapor deposition under the condition of a degree of vacuum of not more than 2×10⁻³ Pa and without heating of the substrate to form a Pd film of 0.1 μm in thickness to fabricate a hydrogen permeable film. In the present comparative example, both the first intermediate layer and the second intermediate layer were not formed. The measurement was conducted in the same manner as in Example 1 and it was found that the amount of permeated hydrogen decreased by 30% from the initial amount of permeated hydrogen 240 minutes after the beginning of the measurement.

### COMPARATIVE EXAMPLE 2

Both surfaces of the same V foil as used in Example 1 were coated with Ta by vapor deposition under the condition of a degree of vacuum of not more than 2×10⁻³ Pa and without heating of the substrate to form a Ta layer of 0.03 μm (30 nm) in thickness. Then, likewise, the surface of each Ta layer was coated with Pd to form a Pd film of 0.1 μm in thickness to fabricate a hydrogen permeable film. In the present comparative example, the second intermediate layer was not formed. The measurement was conducted in the same manner as in Example 1, and it was found that the amount of permeated hydrogen decreased by 30% from the initial amount of permeated hydrogen 900 minutes after the beginning of the measurement.

### COMPARATIVE EXAMPLE 3

A hydrogen permeable film was fabricated in the same manner as in Example 1 except that the second intermediate layer was formed with Cu. The measurement was conducted in the same manner as in Example 1, and it was found that the amount of permeated hydrogen decreased by 30% from the initial amount of permeated hydrogen 900 minutes after the beginning of the measurement.

### COMPARATIVE EXAMPLE 4

A hydrogen permeable film was fabricated in the same manner as in Example 1 except that the second intermediate layer was formed with Ti. The measurement was conducted in the same manner as in Example 1, and it was found that the amount of permeated hydrogen decreased by 30% from the initial amount of permeated hydrogen 1000 minutes after the beginning of the measurement.

The results from Examples 1-4 and Comparative Examples 1-4 are shown in Table 1.

TABLE 1

| | Material for the hydrogen | Material for the first | Material for the second | The outermost | |
|---|---|---|---|---|---|
| | permeable base material | intermediate layer | intermediate layer | layer | Time* |
| Example 1 | V | Ta | Co | Pd | 1500 minutes |
| Example 2 | V | Ta | Ni | Pd | 1200 minutes |
| Example 3 | V—Ni | Ta | Co | Pd | 1500 minutes |
| Example 4 | V | Ta | Co | Pd—Ag | 1800 minutes |
| Comparative | V | — | — | Pd | 240 minutes |
| Example 1 | | | | | |
| Comparative | V | Ta | — | Pd | 900 minutes |
| Example 2 | | | | | |
| Comparative | V | Ta | Cu | Pd | 900 minutes |
| Example 3 | | | | | |
| Comparative | V | Ta | Ti | Pd | 1000 minutes |
| Example 4 | | | | | |

*The time taken for the amount of permeated hydrogen to decrease by 30% from the beginning

As shown in Table 1, in the hydrogen permeable film of Comparative Example 1 where both the first and second intermediate layers were not formed, the time taken for the amount of permeated hydrogen to decrease by 30% from the beginning of the measurement was 240 minutes and decrease of hydrogen permeability over time is large. In the case of the hydrogen permeable film of Comparative Example 2 having only the Ta layer as the first intermediate layer, decrease over time is reduced compared with the hydrogen permeable film of Comparative Example 1, however, the time taken for the amount of permeated hydrogen to decrease by 30% from the beginning of the measurement is 900 minutes, which is still insufficient. Further, in the case where the second intermediate layer was formed of Cu and Ti, respectively (Comparative Examples 3, 4), the time taken for the amount of permeated hydrogen to decrease by 30% from the beginning of the measurement was 900 minutes and 1000 minutes, respectively, which is also insufficient.

In hydrogen permeable film 1 of the present invention where both first intermediate layer 5 and second intermediate layer 6 were formed between hydrogen permeable base material 2 and Pd film 3 (Examples 1-4), the time taken for the amount of permeated hydrogen to decrease by 30% from the beginning was 1200-1800 minutes, which is much longer than the comparative examples. Thus, it is shown that decrease of hydrogen permeability over time can be reduced significantly by forming first intermediate layer 5 and second intermediate layer 6.

It should be understood that the embodiments and examples disclosed herein are illustrative and non-restrictive in every respect. The scope of the present invention is defined by the terms of the claims, rather than the description above, and is intended to include any modifications within the scope and meaning equivalent to the terms of the claims.

1. A hydrogen permeable film, comprising:
a hydrogen permeable base material including V or a V alloy;
a Pd film including Pd or a Pd alloy and having hydrogen permeability; and
an intermediate layer provided between said hydrogen permeable base material and said Pd film and including a first intermediate layer in contact with the hydrogen permeable base material and a second intermediate layer in contact with the Pd film, wherein
said first intermediate layer includes at least one selected from the group consisting of Ta, Nb and an alloy thereof, and
said second intermediate layer includes at least one selected from the group consisting of a Group 8 element, a Group 9 element, a Group 10 element and an alloy thereof and has a thickness of 1 nm-100 nm.

2. The hydrogen permeable film according to claim 1, wherein the first intermediate layer is 10 nm-500 nm in thickness.

3. A fuel battery comprising a hydrogen permeable film according to claim 1 and a proton conductive film provided on a Pd film of the hydrogen permeable film.

4. A fuel battery comprising a hydrogen permeable film according to claim 2 and a proton conductive film provided on a Pd film of the hydrogen permeable film.
